(19) United States
(12) Patent Application Publication
(10) Pub. No.: US 2016/0042233 A1
(43) Pub. Date: Feb. 11, 2016

(54) METHOD AND SYSTEM FOR FACILITATING EVALUATION OF VISUAL APPEAL OF TWO OR MORE OBJECTS

(71) Applicants: Prosenjit Sen, Fremont, CA (US); George C. Papazickos, Fremont, CA (US); Shin-Chen Young, Fremont, CA (US)

(72) Inventors: Prosenjit Sen, Fremont, CA (US); George C. Papazickos, Fremont, CA (US); Shin-Chen Young, Fremont, CA (US)

(73) Assignee: ProSent Mobile Corporation, Fremont, CA (US)

(21) Appl. No.: 14/819,650

(22) Filed: Aug. 6, 2015

Related U.S. Application Data
(60) Provisional application No. 62/033,746, filed on Aug. 6, 2014.

(51) Int. Cl. G06K 9/00; G06T 19/00; G06T 7/40; G06K 9/68; G06F 17/30

(52) U.S. Cl. CPC G06K 9/00671; G06K 9/00201; G06K 9/68; G06F 17/3025; G06F 17/30259; G06T 7/408; G06T 19/006; G06T 2207/20221; G06T 2210/61

(57) ABSTRACT

Disclosed herein is a computer implemented method of facilitating evaluation of visual appeal of a combination of two or more objects. The method may include presenting a user-interface to enable a user to perform a first identification of one or more first objects and a second identification of one or more second objects. Further, the method may include retrieving one or more first images of the one or more first objects based on the first identification. Additionally, the method may include retrieving one or more second images of the one or more second objects based on the second identification. Furthermore, the method may include creating a combination image based on each of the one or more first images and the one or more second images. The combination image may represent a virtual combination of each of the one or more first objects and the one or more second objects.

The present application claims priority from the provisional patent application having Ser. No. 62/033,746, filed on Aug. 6, 2014, the entirety of which is incorporated herein by reference.

### FIELD OF INVENTION

The disclosed methods, systems, and computer readable media generally relate to image processing. More specifically, the disclosed methods, systems and computer readable media relate to facilitating evaluation of visual appeal of a combination of two or more objects.

### BACKGROUND OF INVENTION

There are several situations in which users desire to view a combination of two or more objects. For example, the users may desire to know if the combination of the two or more objects is visually appealing. Accordingly, the users may need to view the combination of the two or more objects in order to evaluate corresponding visual appeal. Further, it may be desirable to view the combination without necessarily requiring physical access to the two or more objects. Currently, in such situations users may be provided with different images corresponding to the two or more objects. However, by individually displaying the different images side-by-side, a realistic representation of the two or more objects may not be achieved.

For example, upon viewing an image of a furniture, a user may desire to know how the furniture may appear while being located in a living room belonging to the user. Currently, an image of the living room and the image of the furniture may be individually displayed side-by-side in close proximity. However, such a display may not provide a realistic view of the furniture located in the living room.

As another example, upon viewing an image of a necklace, the user may desire to know how the necklace may appear while being worn by the user. Currently, an image of the necklace and an image of the user may be individually displayed side-by-side in close proximity. However, such a display may not provide a realistic view of the necklace while being worn by the user.

As yet another example, upon viewing an image of a blouse and an image of a trouser, a user may desire to know how the blouse and the trouser may appear together while being worn by a person. However, an image depicting a person wearing both the blouse and a trouser may not be available. Further, individually displaying the image of the blouse and image of the trouser side-by-side may not provide a realistic view.

Accordingly, in such cases, users are required to imagine the combination of the two or more objects by viewing different images. As a result, users experience inconvenience.

Therefore, there is a need for methods, systems and computer readable media for displaying an image representing the combination of two or more objects in a realistic manner. Such a representation may facilitate, for example, an evaluation of visual appeal corresponding to the combination of the two or more objects.

### SUMMARY OF INVENTION

Disclosed herein is a computer implemented method of facilitating evaluation of visual appeal of a combination of two or more objects. The method may include presenting a user-interface to enable a user to perform a first identification of one or more first objects. The one or more first objects may be associated with one or more object sources of a plurality of object sources. Further, the method may include retrieving one or more first images of the one or more first objects based on the first identification. Additionally, the method may include presenting a user-interface to enable the user to perform a second identification of one or more second objects. The one or more second objects may be associated with one or more object sources. Further, the method may include retrieving one or more second images of the one or more second objects based on the second identification. Furthermore, the method may include creating a combination image based on each of the one or more first images and the one or more second images. The combination image may represent a virtual combination of each of the one or more first objects and the one or more second objects.

In an embodiment, the plurality of object sources may include one or more online stores. Further, a first object of the one or more first objects may be available for purchase at the one or more online stores.

In an embodiment, the one or more first objects may be a merchandise. Further, the one or more second objects may be one or more of a person, a merchandise and a part of a building.

In an embodiment, the one or more object sources associated with the one or more second objects may be included in the plurality of object sources.

In an embodiment, the one or more object sources associated with the one or more second objects may be an image capturing device.

In an embodiment, the one or more object sources associated with the one or more second objects may be a storage device.

In an embodiment, the virtual combination may be based on a spatial relationship between the one or more first objects and the one or more second objects.

In an embodiment, the spatial relationship may be determined based on predetermined physical usage of a first object belonging to a category corresponding to the one or more first objects in relation to a second object belonging to a category corresponding to the one or more second objects.

In an embodiment, the method may further include presenting a user-interface to enable the user to specify the spatial relationship.

In an embodiment, retrieving the one or more first images may include extracting the one or more first images from an image of the one or more first objects.

In an embodiment, the method may further include presenting a user-interface to enable the user to provide an extraction guidance. Additionally, the extracting of the one or more first images may be based on the extraction guidance.

In an embodiment, the method may further include transforming one or more of the one or more first images and the one or more second images.

In an embodiment, the method may further include determining one or more first spatial dimensions of the one or more first objects. Further, the method may include determining one or more second spatial dimensions of the one or more second objects. Additionally, the method may include transforming one or more of the one or more first images and the one or more second images. The transforming may be based on each of the one or more first spatial dimensions and the one or more second spatial dimensions.

In an embodiment, determining the one or more first spatial dimensions may include analysing the one or more first images. Further, determining the one or more second spatial dimensions may include analysing the one or more second images.

In an embodiment, determining the one or more first spatial dimensions may be based on metadata associated with the one or more first images. Further, determining the one or more second spatial dimensions may be based on metadata associated with the one or more second images.

In an embodiment, the method may further include determining a first point of view corresponding to the one or more first images. The first point of view may include spatial coordinates of a hypothetical image capturing device relative to spatial coordinates of the one or more first objects such that the hypothetical image capturing device may capture the one or more first images of the one or more first objects. The method may further include determining a second point of view corresponding to the one or more second images. The second point of view may include spatial coordinates of a hypothetical image capturing device relative to spatial coordinates of the one or more second objects such that the hypothetical image capturing device may capture the one or more second images of the one or more second objects. Additionally, the method may include transforming one or more of the one or more first images and the one or more second images. The transforming may be based on each of the first point of view and the second point of view.

In an embodiment, determining the first point of view may include analysing the one or more first images. Further, determining the second point of view may include analysing the one or more second images.

In an embodiment, the method may further include providing a user-interface to enable the user to provide transformation guidance. Further, the transforming of one or more of the one or more first images and the one or more second images may be based on the transformation guidance.

In an embodiment, creating the combination image may include overlaying the one or more first images onto the one or more second images.

In an embodiment, the method may further include presenting a user-interface to enable the user to provide a style. Further, the method may include modifying the one or more second images based on the style. The one or more second objects may be a person.

### BRIEF DESCRIPTION OF DRAWINGS

FIG. 1 illustrates a flowchart of a method of facilitating evaluation of visual appeal of two or more objects in accordance with an embodiment.

FIG. 2 illustrates a system for facilitating evaluation of visual appeal of two or more objects in accordance with an embodiment.

FIG. 3 illustrates a flowchart of a method of facilitating evaluation of visual appeal of two or more objects in accordance with another embodiment.

FIG. 4 illustrates a system for facilitating evaluation of visual appeal of two or more objects in accordance with another embodiment.

### DETAILED DESCRIPTION

Disclosed herein are methods, systems, apparatus and computer readable media for generating a combination image corresponding to two or more objects. In an instance, the two or more objects may be physical objects. Further, the combination image may visually represent a virtual combination of the two or more objects. Accordingly, the virtual combination of the two or more objects may be formed without necessarily having physical access to the two or more objects. Further, the combination image may be such that the virtual combination of the two or more objects provides a realistic viewing experience. In other words, a user viewing the combination image may have a visual experience similar to that of the user viewing a real combination of the two or more objects. In an instance, the visual experience may be similar with regard to relative spatial locations of the two or more objects. By visually representing the virtual combination of the two or more objects, the user may be enabled to evaluate a visual appeal corresponding to the virtual combination.

In accordance with an embodiment, at step 102, a user-interface may be presented to a user to enable the user to perform a first identification of one or more first objects. The one or more first objects may be one or more of a person, a merchandise and a part of a building. In an embodiment, the one or more first objects may be associated with one or more object sources of a plurality of object sources. In an instance, an object source of the plurality of object sources may be an image source. In another embodiment, the one or more first objects may be associated with one or more image sources of a plurality of image sources. Accordingly, one or more first images of one or more first objects may be identified. Alternatively, in another embodiment, a user-interface may be presented to the user to enable the user to perform a first identification of the one or more first images.

In an embodiment, a first image of the one or more first images may be such that when the first image is displayed on a display device, a user viewing the display device may have a visual experience similar to that of the user viewing the one or more first objects represented in the first image. Accordingly, in an instance, the first image may be a visual representation of the one or more first objects. The first image may be one or more of a two-dimensional image and a three-dimensional image. In an instance, the image may be part of a video. In another instance, the first image may be represented as digital information. For example, the first image may be represented as a two-dimensional matrix of pixel values. The pixel values may be expressed using binary digits. Further, the first image may be stored in a storage device based on a file format. The file format may be one or more of Joint Photographic Experts Group (JPEG), Graphic Interchanges Format (GIF), Bitmap Image File (BMP), Tagged Image File Format (TIFF), Portable Network Graphics (PNG), Exchangeable image file format (EXIF), Raw Image Format (RIF), Computer Graphics Metafile (CGM), Scalable Vector Graphics (SVG), Additive Manufacturing File Format (AMF), X3D, STereoLithography (STL), Universal 3D file format (U3D) and Virtual Reality Modeling Language (VRML).

In an instance, the first image may be obtained from an image capturing device such as a camera. Further, the image capturing device may be configured to capture optical characteristics of the one or more first objects. The optical characteristics may be one or more of reflectance, transmittance, luminance and radiance. In another instance, the first image may be synthesised by a processor. In yet another instance, the first image may be synthesised by a processor based on inputs from a user. For example, a user operating an input device, such as a stylus, may digitally create the first image on an electronic device such as a tablet computer. In another example, the first image may be programmatically created based on an image generating algorithm.

In an embodiment, the first image may be identified based on an input received from a user. The input may be received from an input device, such as for example, a mouse, a stylus or a touch-screen. As an example, the first image may be displayed on a touch-screen of a tablet computer. For instance, the first image may be displayed on a web page of an online store. Further, the user may provide a touch input on the part of the touch-screen corresponding to the first image in order to identify the first image. In another instance, a thumbnail image corresponding to the first image may be displayed on the display device. Further, the user may provide a click input on the thumbnail image in order to identify the first image. In a further instance, the input may include one or more metadata corresponding to the first image. The one or more metadata may include, but is not limited to, an image source, an image type, image resolution, image size, an image context, a file format and one or more image tags. The one or more image tags may represent semantic content of the first image. In an instance, the one or more tags may be semantically related to the one or more first objects represented in the first image. The image context may include information such as, but not limited to, a time when the first image was captured and a location where the first image was captured. In an embodiment, the one or more metadata may relate to the one or more first objects.

Accordingly, the one or more metadata may be, but is not limited to, one or more of a vendor name, a location, a title, a description, a purchase URL, notes, reviews, price, videos and detailed physical description of the one or more first objects such as size, color and material. In an example, a user may provide a keyword through an input device such as a keyboard. Accordingly, based on the keyword, the first image may be identified. Similarly, in another example, the user may provide a name of an object of the one or more first objects. Accordingly, based on the name of the object, the first image may be identified. In an instance, the first image may be identified based on searching one or more image databases. For example, subsequent to receiving the name of the object, a search query may be executed on the one or more image databases. Accordingly, the first image may be a result of executing the search query. In another example, a user may provide a category name corresponding to the one or more first objects. Subsequently, a search query including the category name may be executed on the one or more image databases. Thereafter, a result of executing the search query may be displayed to the user. In an instance, the result may include a set of images. Upon viewing the result, the user may select the first image from the set of images.

In an embodiment, subsequent to identifying the one or more first images, retrieval of the one or more first images may be performed at step 104 based on the first identification. The retrieval of the one or more first images may be performed by accessing one or more image sources. In an embodiment, the one or more image sources may correspond to one or more object sources such as, but not limited to, online stores. In an instance the one or more image sources may include, but are not limited to, a storage device, an image capturing device and an image generating device. Examples of the one or more image sources may include websites, social networks, cameras and photo libraries. In an embodiment, the storage device may be located in a client device of the user. Accordingly, a first image of the one or more first images may be uploaded from the storage device located on the client device to a server. In another embodiment, the storage device may be located in a server which may be in communication with the client device of the user. Further, the server may provide a service of generating the combination image. In another embodiment, the storage device may be located in an external server in communication with the server. In an embodiment, the external server may correspond to an online store. In another embodiment, the first image may be retrieved from an image capturing device. In an instance, the image capturing device may be located on a client device of the user. For example, a tablet computer of the user may have an inbuilt image capturing device, such as a camera. Accordingly, the user may capture the first image using the camera. Subsequently, the first image may be uploaded to the server. In another embodiment, the first image may be stored on the storage device associated with the tablet computer. For instance, the first image may be present in a photo library in the tablet computer. In another embodiment, the first image may be retrieved from an image generating device which may be, for example, a graphics processor configured for generating images. In another embodiment, the first image may be retrieved from the one or more image databases. In an embodiment, the first image may be available with an external server. Further, the server providing a service of creating the combination image may be in communication with the external server. Accordingly, the server may retrieve the first image from the external server. In an embodiment, the external server may correspond to an online store. Accordingly, the online store may enable the user to purchase the one or more first objects represented by the first image. Moreover, in an embodiment, the server may be configured for providing an access to a user to the external server. For example, a user may connect to the server through a client device of the user. Further, the server may provide a user-interface, such as a browser, to be displayed on the client device. Furthermore, the user-interface may be such that user may be enabled to access the external server. In an embodiment, the server may be in communication with two or more external servers. Further, the two or more external servers may correspond to two or more online stores. Accordingly, the server may provide a single user-interface to the user in order to access an online store of the two or more online stores. In an instance, the two or more online stores may be unaffiliated. In another instance, a service provider of the server and a service provider of an external server may be unaffiliated.

In an embodiment, subsequent to retrieving the one or more first images, the one or more first images may be stored in a temporary storage device of the server. An example of the temporary storage device may be random access memory. In another embodiment, the one or more first images may be stored on a permanent storage device of the server. An example of a permanent storage device may be a hard disk.

In an embodiment, the one or more first images may be subjected to one or more pre-processing steps. The one or more pre-processing steps may be required to convert a first image of the one or more first images into a form suitable for further processing. For example, the one or more pre-processing steps may alter one or more attributes of the first image. The one or more attributes may include one or more of, but not limited to, image size, image resolution, image type and a file format.

In an embodiment, the first image may be such that image elements corresponding to objects other than the one or more first objects may be transparent. For example, image elements corresponding to a background of the one or more first objects may be transparent image elements. Examples of image elements may include, but are not limited to, pixels and voxels. In this case, the one or more first objects may be of interest to the user. Accordingly, when the first image is rendered, image elements corresponding to objects other than the one or more first objects may be rendered transparently. As a result, in a rendering of the first image, the transparent image elements may assume corresponding values of a background of the rendering.

In an embodiment, the first image may be such that image elements corresponding objects other than the one or more first objects may be non-transparent image elements. Accordingly, the first image may be subjected to an image extraction step. An objective of the image extraction step may be to identify image elements corresponding to objects other than the one or more first objects and subsequently transform the identified image elements from non-transparent image elements to transparent image elements. In an instance, the image extraction step may be performed based on object recognition. For example, the first image may be analysed automatically by a processor in order to recognise the one or more first objects represented in the first image. The processor may be configured to execute program code embodying an object recognition algorithm. Further, objects other than the one or more first objects may also be recognised based on the analysing. Subsequently, image elements corresponding to objects other than the one or more first objects may be converted to transparent image elements. In an embodiment, an extraction guidance, in the form of an input from a user, may be received in order to identify objects other than the one or more first objects in the first image. Accordingly, the user may be presented with an interface including a display of the first image. In an instance, the user may click one or more contiguous image regions on the first image. The one or more contiguous image regions may include image elements having similar values. Further, the one or more contiguous image regions may correspond to objects other than the one or more first objects. For example, the user may point a mouse cursor over a background region on the first image. Accordingly, image elements corresponding to the background region may be converted into transparent image elements. In an embodiment, image elements corresponding to the background region which are surrounded by image elements corresponding to the one or more first objects may be identified based on extraction guidance from the user.

In an embodiment, the method may further include determining one or more spatial dimensions corresponding to the one or more first objects represented in the first image. In an instance, the one or more spatial dimensions may be absolute measures of one or more of a length, a breadth and a width of the one or more first objects. Further, the one or more spatial dimensions may represent an actual physical dimension of the one or more first objects along one or more spatial axes, such as an X-axis, a Y-axis and a Z-axis. In an instance, the one or more spatial dimensions corresponding to the one or more first objects may be an actual size of the one or more first objects. The actual size may be expressed in a suitable measure of units such as, for example, inches or centimetres. Consider a case where the one or more first objects may be an apparel, such as a blouse, designed to be worn by a person. The size may be expressed in a standard system of measurements such as, but not limited to, the International Organization of Standards (ISO), for example, ISO/TR 10652:1991. The actual size in accordance with the standard system of measurements may correspond to a predefined range of actual physical dimensions.

In an embodiment, the one or more spatial dimensions may be determined based on metadata corresponding to the first image. The metadata, in general, may include information relating to the one or more first objects in the first image. In another embodiment, the metadata may also include information relating to objects other than the one or more first objects. The objects other than the one or more first objects may also be represented in the first image. In an embodiment, the metadata may be included in a header portion of a file comprising the first image. In another embodiment, the metadata information may be included on a page comprising a display of the first image. For example, a page displaying the first image may also display metadata corresponding to the first image. As an example, a web page of an online store selling jewellery may also display metadata corresponding to the one or more first objects, such as a necklace. The metadata corresponding to the necklace may include information such as an actual length of the necklace. The actual length may be expressed in suitable units, such as for example, centimetres or inches. Alternatively, the actual length may be expressed in terms of a standard system of measurements. As an example, the standard system of measurements may specify categories of sizes corresponding to which predefined lengths may be determined. For example, the standard system of measurements may include one or more of a small size, a medium size, a large size and an extra large size.

In an embodiment, the one or more spatial dimensions may be determined based on image analysis performed on the first image. For instance, the image analysis may include counting a number of image elements corresponding to the one or more first objects along an axis corresponding to the first image. For example, in case the first image is a two dimensional image, by counting the number of image pixels corresponding to the one or more first objects along an x-axis, a length of the one or more first objects along the x-axis may be determined. In an embodiment, the length may be determined based on a scaling factor. In an instance, the scaling factor may represent a physical distance between the one or more first objects and an image capturing device which captured the first image. In another instance, the scaling factor may represent an optical zoom parameter corresponding to the image capturing device which captured the first image. As an example, consider a case where the image capturing device is physically far from the one or more first objects. Accordingly, the first image captured by the image capturing device may be such that an image size corresponding to the one or more first objects along a given axis may be shorter as compared to a case where the image capturing device is nearer to the one or more first objects. The image size may be expressed, for example, in terms of number of image elements. Based on the number of image elements and actual dimensions of a display screen configured for displaying the first image, a corresponding dimension in centimetres may be determined. Alternatively, the image size may be expressed, for example, in centimetres. In an embodiment, the image capturing device may be configured in such a way that the scaling factor may be stored in the first image as metadata corresponding to the first image. Accordingly, the image capturing device may include at least one sensor configured for measuring the distance between the image capturing device and the one or more first objects. In another embodiment, the scaling factor may be embedded in the first image in the form of image elements.

In another embodiment, the one or more spatial dimensions may be relative measures of the one or more first objects. The relative measures may indicate one or more of a length, a width and a breadth of at least one object of the one or more first objects in relation to at least one other object of the one or more first objects. In another instance, the relative measures may indicate one or more of a length, a width and a breadth of the one or more first objects in relation to an object other than the one or more first objects. The object other than the one or more first objects may also be represented in the first image. For example, consider the first image representing a necklace being worn by a user. Accordingly, a spatial dimension corresponding to the necklace, such as, for example, a length may be represented in terms of a length of the neck of the user wearing the necklace. Moreover, based on a predetermined range of spatial dimensions corresponding to the object other than the one or more first objects, the one or more spatial dimensions of the one or more first objects may be determined. For example, a breadth of the neck of a user may be approximately known based on a predetermined range of breadths statistically observed across a large number of users. As a result, an estimate of the one or more spatial dimensions of the one or more first objects may be obtained. Accordingly, in an embodiment, image analysis may be performed on the first image in order to determine an image size of the neck of the user and an image size of the necklace. The image size may be expressed in terms of number of image elements, such as, for example, pixels. Based on predetermined knowledge of a range of breadths corresponding to necks of users, a breadth of the neck may be approximated. Further, based on the breadth, an actual length of the necklace may be estimated. Moreover, based on a ratio of the actual length and the image size of the necklace, a scaling factor may be determined. The scaling factor may then be used to calculate another spatial dimension of the necklace, such as, for example, a breadth of the necklace.

Further, in an embodiment a point of view corresponding to the first image may be determined. The point of view may be represented by spatial coordinates of a hypothetical image capturing device in relation to spatial coordinates of the one or more first objects represented in the first image. Further, the point of view may additionally include information regarding an optical zoom parameter corresponding to the hypothetical image capturing device.

In an embodiment, a point of view corresponding to the first image may be determined based on image analysis. For example, the first image may be analysed and the one or more first objects represented in the first image may be recognised. Further, based on predetermined characteristics of the one or more first objects, a point of view corresponding to the first image may be automatically determined. For instance, based on knowledge of a three-dimensional shape of the one or more first objects represented in the first image, an angular orientation of the hypothetical image capturing device in relation to the one or more first objects represented in the first image may be determined. Consider, for example, the one or more first objects represented in the first image which may be a pair of shoes. Based on image analysis of the first image, a point of view corresponding to the first image may be determined based on knowledge about three-dimensional shape of the pair of shoes. For instance, the point of view may be determined as a frontal view.

In another embodiment, a point of view corresponding to the first image may be determined based on metadata corresponding to the first image. For instance, an image capturing device which captured the first image may be configured for storing a point of view as metadata of the first image. In another embodiment, the metadata including the point of view corresponding to the first image may be retrieved from a web page displaying the first image. In an embodiment, the point of view corresponding to the first image may be expressed in polar coordinates with the one or more first objects considered as the reference point. In another embodiment, the point of view corresponding to the first image may be expressed as one or more of a front view, a back view, a left side view, a right side view, a top view, a bottom view and a perspective view.

In an embodiment, in addition to identifying the one or more first images, one or more second images representing one or more second objects may be identified. Accordingly, at step 106, a user-interface may be presented to the user to enable the user to identify the one or more second objects. In an instance, the one or more second objects may be one or more of a person, a merchandise and a part of a building. Alternatively, in another embodiment, the user-interface may enable the user to identify the one or more second images. A second image of the one or more second images may be a visual representation of the one or more second objects. In an instance, a category corresponding to the one or more first objects represented in the first image may be different from a category corresponding to the one or more second objects represented in the second image. The category may correspond to one or more of, but not limited to, fashion, accessories, makeup, wellness, hair styling, home furnishings and consumer electronics. As an example, the one or more first objects represented in the first image may be jewellery, such as, for example, a necklace. Accordingly, the one or more second objects represented in the second image may be a person. Further the second image may be such that the head and the neck of the person may be visible. In another instance, a category corresponding to the one or more first objects represented in the first image may be identical to the category corresponding to the one or more second objects represented in the second image. As an example, the one or more first objects represented in the first image may be furniture such as a table. Accordingly, the one or more second objects represented in the second image may be another furniture such as, for example, a wall mounted cupboard. In another example, the one or more first objects represented in the first image may be furniture such as a sofa. Accordingly, the one or more second objects represented in the second image may be an interior space of a living room.

In another embodiment, an image source corresponding to the first image may be different from an image source corresponding to the second image. For example, the first image may be obtained from a webpage of an online store and the second image may be uploaded from a client device of a user. In another embodiment, an object source corresponding to the first image may be different from an object source corresponding to the second image. An object source may be, for example, an online store from where the object may be purchased. Accordingly, the one or more first objects represented in the first image may be available for purchase at a first online store and the one or more second objects represented in the second image may be available for purchase at a second online store.

In an embodiment, subsequent to identifying the one or more second images, retrieval of the one or more second images may be performed at step 108. In an embodiment, the one or more second images may be retrieved from an image source. In an embodiment, the image source may be the one or more image sources.

In an embodiment, a second image of the one or more second images may be stored in a temporary storage device corresponding to the server. In another embodiment, the second image may be stored on a permanent storage device of the server. Thereafter, in an embodiment, one or more pre-processing steps may be performed on the second image. In an instance, the one or more pre-processing steps may include altering one or more attributes corresponding to the second image. The one or more attributes may be, but are not limited to, image size, image resolution, image type and a file format.

In an embodiment, the second image may be such that image elements corresponding to objects other than the one or more second objects represented in the second image may be transparent image elements. In another embodiment, the second image may be such that image elements corresponding to objects other than the one or more second objects represented in the second image may be non-transparent image elements. Accordingly, in an embodiment image elements corresponding to objects other than the one or more second objects represented in the second image may be identified and subsequently converted into transparent image elements.

Further, in an embodiment, one or more spatial dimensions corresponding to the one or more second objects represented in the second image may be determined. In another embodiment, a point of view corresponding to the second image may also be determined.

It may be understood that embodiments described in relation to the one or more first images may be applicable to the one or more second images.

At step 110, based on each of the one or more first images and the one or more second images, a combination image may be created. The combination image may represent a virtual combination of each of the one or more first objects and the one or more second objects. In an embodiment, the virtual combination may be based on a spatial relationship between the one or more first objects and the one or more second objects. For example, the one or more first objects may be a garment and the one or more second objects may be a person. Accordingly, the virtual combination of the garment and the person may be based on a spatial relationship between the garment and the person while the person is wearing the garment. For instance, the combination image may be such that the garment may appear to be worn by the person. In another embodiment, the spatial relationship may be determined based on predetermined physical usage of a first object belonging to a category corresponding to the one or more first objects in relation to a second object belonging to a category corresponding to the one or more second objects. For example, the one or more objects may be a head-scarf and the one or more second objects may be a person such as a woman. Accordingly, it may be determined that the head-scarf is generally worn around the head of a person. Therefore, the combination image may be created such that the head-scarf appears to be worn by the woman around her head. In yet another embodiment, the method may further include presenting a user-interface to enable the user to specify the spatial relationship. Accordingly, the user may control relative spatial location of the one or more first objects with respect to the one or more second objects. For example, the one or more first objects may be a vase and the one or more second objects may be a wall mounted shelf. Accordingly, the user may specify a location in the wall-mounted shelf where the vase may be placed. As another example, the one or more first objects may be a nose stud and the one or more second objects may be the user. Accordingly, the user may specify the side of the user's nose on which the nose stud may be located.

Further, in an embodiment, the method may further include transforming at least one of the one or more first images and the one or more second images. In an instance, the transforming may include, but is not limited to, one or more of resizing and rotating. In an instance, an aspect ratio of one or more of the one or more first images and the one or more second images may be the same before and after the transforming. In another embodiment, the transforming may be based on each of one or more spatial dimensions corresponding to the one or more first objects and one or more spatial dimensions corresponding to the one or more second objects. For example, a first image of the one or more first images may represent an ear-ring. Further, the first image may be such that the ear-ring may be represented at a magnified scale in order to reveal intricate art work of the ear-ring. Accordingly, an image size of the ear-ring may be larger than an actual physical size of the ear-ring. Further, a second image of the one or more second images may represent a head shot of a person at a reduced scale. Accordingly, an image size of the face of the person may be smaller than an actual physical size of the face. In order to create the combination image depicting the person wearing the ear-ring in a realistic manner, the first image may be reduced in size. In an instance, the reduction in size may be performed till an image size to actual size ratio of the first image matches that of the second image. Alternatively, the second image may be enlarged in order to bring an image size to actual size ratio of the second image at par with that of the first image. In another embodiment, the transforming may be based on each of a first point of view corresponding to the one or more first images and a second point of view corresponding to the one or more second images. In another embodiment, the method may further include providing a user-interface to enable the user to provide a transformation guidance. For example, the user may be allowed to rotate one or more of the first image and the second image in order to create a desired spatial relationship between the one or more first objects and the one or more second objects. Further, the transforming of at least one of the one or more first images and the one or more second images may be based on the transformation guidance.

In an embodiment, creating the combination image may include overlaying the one or more first images onto the one or more second images. Accordingly, values corresponding to image elements of the first image may replace values corresponding to image elements of the second image.

In a further embodiment, the method may include presenting a user-interface to enable the user to provide a style. Further, based on the style, one or more of the one or more first images and the one or more second images may be modified. In an instance, the one or more second objects may be a person. Accordingly, a style corresponding to the one or more first images, such as, for example, a hair style and a make-up of the person may be modified.

In an embodiment, the user may share the combination image with one or more other users. For example, the user may share the combination image through a social network. Accordingly, the user may obtain feedback from the one or more other users on the combination image. Such feedback may be based on evaluation of visual appeal of the virtual combination of the one or more first objects and the one or more second objects represented in the combination image. Consequently, based on the feedback, the user may make a decision to purchase one or more of the one or more first objects and the one or more second objects.

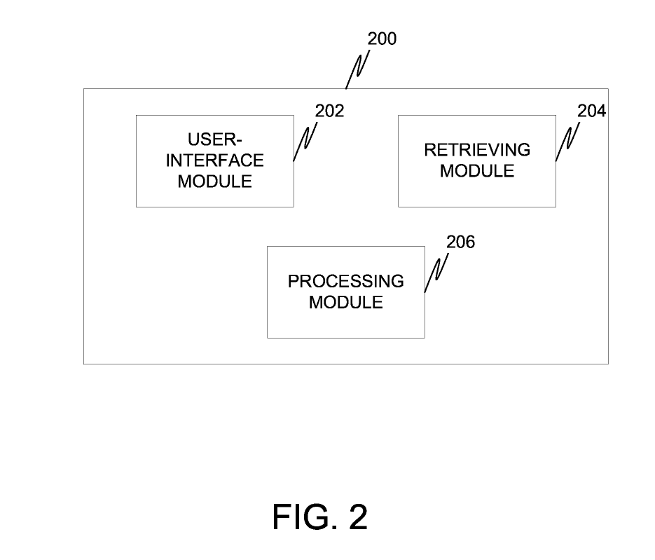

FIG. 2 illustrates a system 200 for facilitating evaluation of visual appeal of the two or more objects in accordance with an embodiment. System 200, in an embodiment may be implemented as a web server. In another embodiment, system 200 may be implemented on a client device of a user such as, but not limited to, a smart-phone, a tablet computer, a laptop and desktop computer. In another embodiment, system 200 may be implemented as a combination of a client and a server. System 200 may include a user-interface module 202 configured for presenting the user-interface to enable the user to perform the first identification of the one or more first objects. The user-interface may be for example, a browser, such as a web-browser. In an embodiment, the user-interface may be touch-based. Accordingly, the user-interface may be presented to the user on a touch-screen. User-interface module 202 may further be configured for presenting the user-interface to enable the user to perform the second identification of the one or more second objects.

Further, system 200 may include a retrieving module 204 configured for retrieving the one or more first images of the one or more first objects based on the first identification. Further, retrieving module 204 may be configured to communicate with the one or more image sources such as an image capturing device, one or more image databases and one or more external servers (not shown in figure). In another embodiment, retrieving module 204 may be configured to communicate with the one or more object sources, such as the one or more online stores. The communication may take place over one or more of a wired communication channel and a wireless communication channel. In an example, the communication may take place over a network such as, the Internet. Further, retrieving module 204 may be configured for retrieving the one or more second images of the one or more second objects based on the second identification.

Furthermore, system 200 may include a processing module 206 configured for creating the combination image based on each of the one or more first images and the one or more second images. The combination image may represent a virtual combination of each of the one or more first objects and the one or more second objects. In an embodiment, processing module 206 may be implemented as one or more of a microprocessor, a graphics processor, a microcontroller, an Application Specific Integrated Circuit (ASIC) and a Field Programmable Gate Array (FPGA). Further, processing module 206 may be implemented at one or more of a client side and a server side.

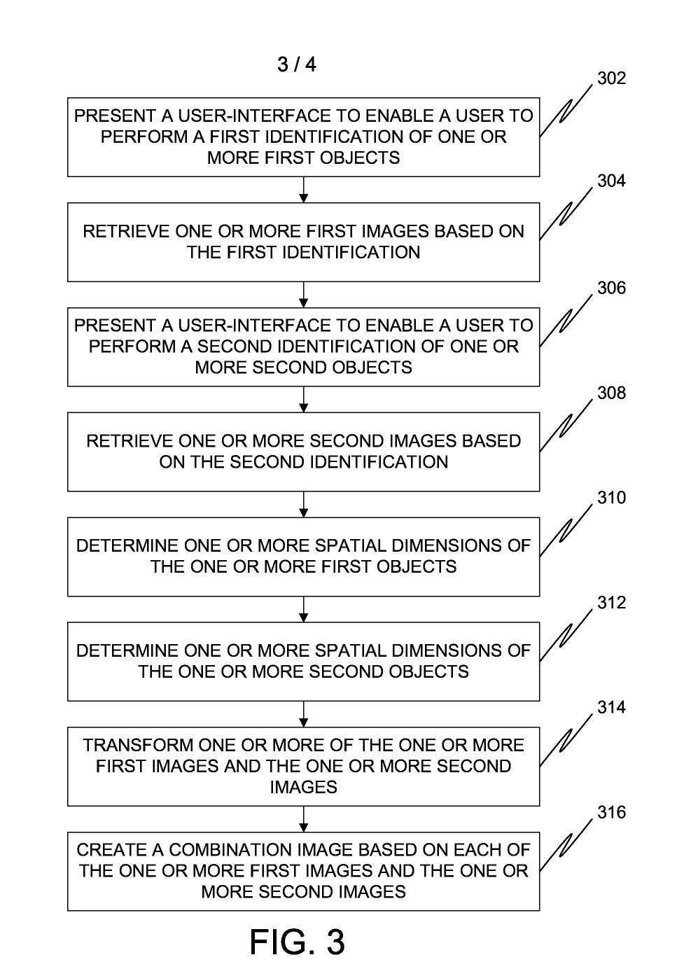

FIG. 3 illustrates a flowchart of a method of facilitating evaluation of visual appeal of the two or more objects in accordance with another embodiment. At step 302, the user-interface may be presented to a user in order to enable the user to perform the first identification of the one or more first objects. For example, the user-interface may be a mobile application executable on a client device, such as a smart-phone, of the user. In an instance, the user-interface may be a portal to an online store of the one or more online stores. Accordingly, through the user-interface, the user may be able to view products available for purchase at the online store. As an example, the one or more objects may be a necklace set consisting of a pair of ear-rings and a necklace. Moreover, the necklace set may be available for purchase at the online store of the one or more online stores. For instance, the ear-ring of the necklace set may be available at a first online store of the one or more online stores. The necklace of the necklace set may be available at a second online store of the one or more online stores.

Subsequent to receiving the first identification, the one or more first images may be retrieved based on the first identification at step 304. For example, a first image of the ear-ring may be retrieved from a webpage of the first online store. Similarly, a first image of the necklace may be retrieved from a webpage of the second online store.

Thereafter, at step 306, the user-interface may be presented to the user to enable the user to perform the second identification of the one or more second objects. The one or more second objects may be for example, the user.

Accordingly, at step 308, the one or more second images representing the one or more second objects may be retrieved based on the first identification. For example, a second image of the one or more second images depicting the user's face may be retrieved. In an instance, the second image may be retrieved from a photo library of the client device of the user. In another instance, the user may take a photograph of self using the image capturing device inbuilt in the client device. Further, the photograph may be such that the face, ears and neck of the user are visible. Subsequently, the photograph may be retrieved.

In another embodiment, the one or more second images may be automatically retrieved based on the first identification. For example, based on the first identification, a category of the one or more first objects may be determined. The category may be determined to be, for example, a necklace set. Accordingly, based on the category, a corresponding second object of the one or more second objects may be identified. For instance, such relationships between the one or more first objects and the one or more second objects may be predetermined and stored. Examples of such predefined pair of categories of objects include, but are not limited to, head:head-scarves, head:hats, ear-rings:face, nose studs:face, necklace:face, furniture:interior of a room, shoes:legs, handbags:torso, blouses:torso, t-shirts:torso, trousers:legs, eyewear:head and rings:hand. Accordingly, subsequent to determining the category as necklace set, the second image depicting the user's face may be automatically identified and retrieved. In an instance, the second image may be automatically identified by executing a tag based search. In another instance, the second image may be automatically identified by image analysis of one or more images in the photo gallery belonging to the user. The image analysis may include, for example, object recognition. Accordingly, in an instance, an image from the photo gallery may be identified as the second image if the image prominently depicts the face of the user including the user's neck.

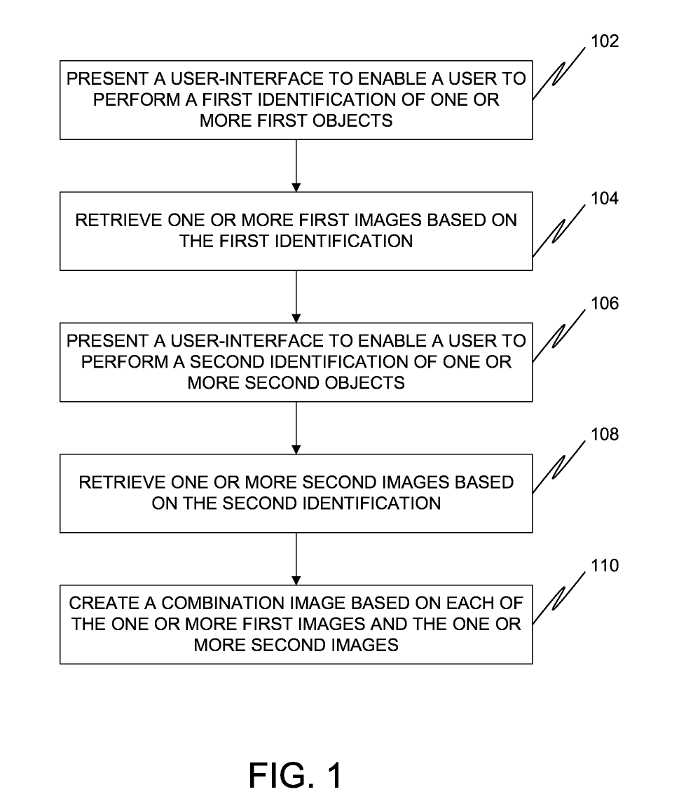

Further details regarding steps 302 to 308 may be understood by referring to description of steps 102 to 108 of FIG. 1.

At step 310, one or more first spatial dimensions of the one or more first objects may be determined. For instance, a webpage of the online store selling the necklace set may be parsed in order to extract metadata corresponding to characteristics of the necklace set. Such characteristics may include spatial dimensions of the necklace set such as a length and breadth of the necklace and a diameter of the ear-rings. In an embodiment, the webpage may include the metadata in a structured format such as for example, parameter value pairs. Accordingly, a value of a parameter corresponding to spatial dimensions may be retrieved. In another embodiment, textual information on the webpage may be subjected to textual analysis such as one or more of syntactic analysis and semantically analysis in order to determine the one or more first spatial dimensions of the one or more first objects. Further, at step 312, the one or more second spatial dimensions of the one or more second objects may also be determined. For example, based on each of a distance of the image capturing device from the user and an image size corresponding to the user's face, spatial dimensions of the user's face may be determined.

At step 314, one or more of the one or more first images and the one or more second images may be transformed. Further, the transforming may be based on each of the one or more first spatial dimensions and the one or more second spatial dimensions. In an instance, the first image representing the necklace set may be such that an image size corresponding to the necklace set may be larger than an actual size of the necklace set. The image size may be expressed in, for example, centimetres. As an example, a ratio of the image size corresponding to the necklace to the actual size of the necklace may be 2:1. Further, the second image representing the user's face may be such that a ratio of the image size corresponding to the user's face to the actual size of the user's face may be 1:2. Accordingly, the first image may be transformed by rescaling the first image such that the ratio of the image size corresponding to the necklace to the actual size of the necklace may be 1:2.

Subsequently, at step 316, the combination image based on each of the one or more first images and the one or more second images may be created. In an instance, the combination image may be created by overlaying the first image over the second image. Further, an image size to actual size ratio corresponding to the first image may be substantially equal to an image size to actual size ratio corresponding to the second image. As a result, the combination image may be such that the visual representation of the necklace set on the user may appear as if the user were wearing the necklace set in real. In an embodiment, the combination image may be created based on a predetermined spatial relationship between the necklace set and the user. For example, the pair of ear-rings may be determined to be located on the ears of the user. Accordingly, the combination image may be created such that image elements corresponding to the ear-rings in the first image may be overlaid on image elements corresponding to the ears of the user in the second image. In an embodiment, the user may be presented with a user-interface to enable the user to alter the spatial relationship. For example, the user may be enabled to move an image portion representing the ear-rings on an image portion representing the ears as per the user's desire. As a result, the user may be able to view the combination of the necklace set and the user's face as if the user were wearing the necklace set. Accordingly, the user may be able to evaluate the visual appeal of the necklace set.

Consequently, based on the evaluation, a likelihood of the user deciding to purchase the necklace set may be increased. In order to facilitate purchase, the user-interface may further be configured to enable the user to buy the necklace set. In another embodiment, the user may be re-directed to a webpage of the online store in order to purchase the necklace set. Further, the redirection may include a referrer identification corresponding to the user-interface. The referrer identification may represent a service provider providing a service of creating the combination image.

In an embodiment, the service provider may be engaged in an agreement with a seller corresponding to the online store. Further, the agreement may be such that, the seller may pay a predetermined commission fee to the service provider for purchases of merchandise sold by the seller, wherein the purchases may be made through the user-interface provided by the service provider. In another embodiment, the agreement may be such that the seller may pay a predetermined commission fee to the service provider for purchases of merchandise sold by the seller, wherein the purchases may be made based on redirections of users from the user-interface to a webpage of the online store.

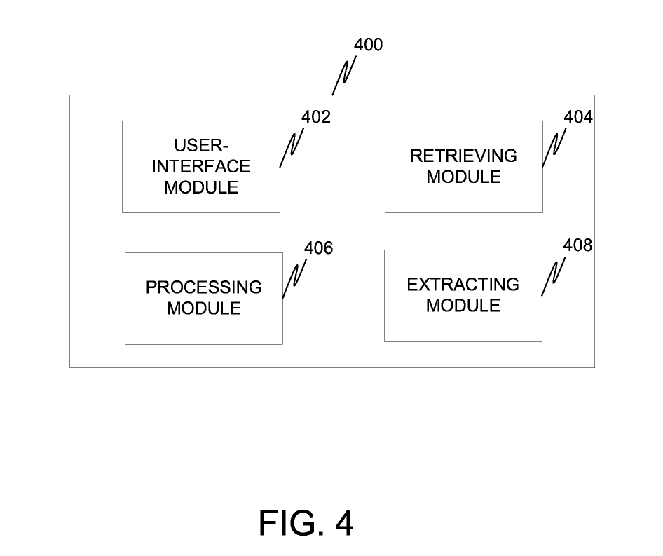

FIG. 4 illustrates a system 400 for facilitating evaluation of visual appeal of a combination of the two or more objects in accordance with another embodiment. System 400 may be an instance of system 200. Accordingly, system 400 may include a user-interface module 402 configured for presenting the user-interface to enable the user to perform the first identification of the one or more first objects. User-interface module 402 may further be configured for presenting the user-interface to enable the user to perform the second identification of the one or more second objects. Further, system 400 may include a retrieving module 404 configured for retrieving one or more first images of the one or more first objects based on the first identification. Further, retrieving module 404 may be configured for retrieving the one or more second images of the one or more second objects based on the second identification. Furthermore, system 400 may include a processing module 406 configured for creating the combination image based on each of the one or more first images and the one or more second images. The combination image may represent a virtual combination of each of the one or more first objects and the one or more second objects. Moreover, system 400 may include an extracting module 408 configured for extracting the one or more first images from an image of the one or more first objects. For example, in an instance, the image of the one or more first objects may include objects other than the one or more objects, such as a background. Accordingly, extracting module 408 may be configured to extract an image portion corresponding to the one or more objects while leaving out an image portion corresponding to objects other than the one or more objects. Similarly, extracting module 408 may be configured for extracting the one or more second images from an image of the one or more second objects.

In an instance, extracting module 408 may be configured to execute an Image Extraction Algorithm. In an embodiment, the Image Extraction Algorithm may utilize multiple passes in order to extract the one or more first images from the image. Initially, a first pass may be performed based on a medium contrast value. Subsequently, results of the first pass may be displayed to the user along with a slider control in the user-interface. Upon visual inspection, the user may accept the results of the first pass. Alternatively, the user may choose to make a second pass using an updated contrast value. The user may adjust the slider control up or down to select a higher or lower contrast value. Thereafter, the second pass of the Image Extraction Algorithm may be performed based on the updated contrast value. This process may be repeated until the user may be satisfied with the results.

A step in the Image Extraction Algorithm may convert the image into a grayscale image using a library function available from openCV. The grayscale image may then be passed to a canny edge algorithm available from openCV. Additionally, the contrast value may also be passed as an input parameter to the canny edge algorithm. The output of the canny edge algorithm may be a contour image depicting the edge contours of the image.

Subsequently, a silhouette image may be generated from the contour image by filling the areas inside the contour edges in the contour image. As a result, a negative mask image which is a black and white image with the original colors reversed may be formed. The negative mask image may then be converted to a positive mask image by inverting the colors. Thereafter, the positive mask image may be applied to the image. Areas of the image that are not covered by the positive mask image may be removed.

In another embodiment, the Image Extraction Algorithm may remove areas of the background which are contiguous with outer edges of the image. However, in some cases, the image extraction algorithm may not remove patches of the background which are bounded by foreground image elements. The foreground image elements may correspond to the one or more first objects that are of interest to the user. For example, these patches of the background may be between an image portion corresponding to an arm and an image portion corresponding to the body of a clothing model depicted in the image. In such cases, user-interface module 402 may be further configured for presenting a user-interface to enable the user to provide the extraction guidance. For example, the user may provide the extraction guidance by providing a touch-input on a touch-screen displaying the image. The touch-input may be provided on a region of the touch-screen displaying the patches of the background.

In an embodiment, subsequent to receiving the touch-input, a corresponding touch point is identified and converted from a screen coordinate system to an image coordinate system. A coordinate in the image coordinate system may be relative to the upper left point of the image rather than the upper left point of the touch-screen. Thereafter, a horizontal offset value and a vertical offset value may be calculated from the difference between the origin of the touch-screen and the upper left corner of the image on the touch-screen. Each of the horizontal offset value and the vertical offset value may then be used to convert between the screen coordinate system and the image coordinate system.

Subsequently, the Image Extraction Algorithm may create a mask based on the outline contour of a region containing the touch point. Each of the touch point and the mask may be passed to a floodfill function provided by a program code library such as, OpenCV. The floodfill function may detect image points contiguous with the touch point which have a similar color as that of the touch point. Accordingly, a boundary of the region with the color may be detected. Based on the boundary, a mask may be generated. The mask may then be applied to the image so that the region may be removed.

The described techniques may be implemented as a method, apparatus or article of manufacture involving software, firmware, micro-code, hardware and/or any combination thereof. The term “article of manufacture” as used herein refers to code or logic implemented in a medium, where such medium may comprise hardware logic [e.g., an integrated circuit chip, Programmable Gate Array (PGA), Application Specific Integrated Circuit (ASIC), etc.] or a computer readable medium, such as magnetic storage medium (e.g., hard disk drives, floppy disks, tape, etc.), optical storage (CD-ROMs, optical disks, etc.), volatile and non-volatile memory devices [e.g., Electrically Erasable Programmable Read Only Memory (EEPROM), Read Only Memory (ROM), Programmable Read Only Memory (PROM), Random Access Memory (RAM), Dynamic Random Access Memory (DRAM), Static Random Access Memory (SRAM), flash, firmware, programmable logic, etc.]. Code in the computer readable medium is accessed and executed by a processor. The medium in which the code or logic is encoded may also comprise transmission signals propagating through space or a transmission media, such as an optical fiber, copper wire, etc. The transmission signal in which the code or logic is encoded may further comprise a wireless signal, satellite transmission, radio waves, infrared signals, Bluetooth, etc. The transmission signal in which the code or logic is encoded is capable of being transmitted by a transmitting station and received by a receiving station, where the code or logic encoded in the transmission signal may be decoded and stored in hardware or a computer readable medium at the receiving and transmitting stations or devices. Additionally, the “article of manufacture” may comprise a combination of hardware and software components in which the code is embodied, processed, and executed. Of course, those skilled in the art will recognize that many modifications may be made without departing from the scope of embodiments, and that the article of manufacture may comprise any information bearing medium. For example, the article of manufacture comprises a storage medium having stored therein instructions that when executed by a machine results in operations being performed. Certain embodiments can take the form of an entirely hardware embodiment, an entirely software embodiment or an embodiment containing both hardware and software elements. In an embodiment, the invention may be implemented in software, which includes but is not limited to firmware, resident software, microcode, etc.

Furthermore, certain embodiments can take the form of a computer program product accessible from a computer usable or computer readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

The terms “certain embodiments”, “an embodiment”, “embodiment”, “embodiments”, “the embodiment”, “the embodiments”, “one or more embodiments”, “some embodiments”, and “one embodiment” mean one or more (but not all) embodiments unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise. Further, relational terms such as first and second, top and bottom, and the like may be used solely to distinguish one entity or action from another entity or action without necessarily requiring or implying any actual such relationship or order between such entities or actions.

Devices that are in communication with each other need not be in continuous communication with each other, unless expressly specified otherwise. In addition, devices that are in communication with each other may communicate directly or indirectly through one or more intermediaries. Additionally, a description of an embodiment with several components in communication with each other does not imply that all such components are required. On the contrary a variety of optional components are described to illustrate the wide variety of possible embodiments.

Furthermore, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously, in parallel, or concurrently.

When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article. The functionality and/or the features of a device may be alternatively embodied by one or more other devices which are not explicitly described as having such functionality/features. Thus, other embodiments need not include the device itself.

Computer program means or computer program in the present context mean any expression, in any language, code or notation, of a set of instructions intended to cause a system having an information processing capability to perform a particular function either directly or after either or both of the following a) conversion to another language, code or notation; b) reproduction in a different material form.

The above-disclosed subject matter is to be considered illustrative, and not restrictive, and the appended claims are intended to cover all such modifications, enhancements, and other embodiments that fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

While the present invention has been described in the foregoing embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadcast interpretation so as to encompass all such modifications and equivalent structures and functions.

What is claimed is:

1. A computer implemented method of facilitating evaluation of visual appeal of a combination of at least two objects, the method comprising:
a. presenting a user-interface to enable a user to perform a first identification of at least one first object associated with at least one object source of a plurality of object sources;
b. retrieving at least one first image of the at least one first object based on the first identification;
c. presenting a user-interface to enable the user to perform a second identification of at least one second object associated with at least one object source;
d. retrieving at least one second image of the at least one second object based on the second identification; and
e. creating a combination image based on each of the at least one first image and the at least one second image, wherein the combination image represents a virtual combination of each of the at least one first object and the at least one second object.

2. The computer implemented method of claim 1, wherein the plurality of object sources comprises at least one online store, wherein a first object of the at least one first object is available for purchase at the at least one online store.

3. The computer implemented method of claim 1, wherein the at least one first object is a merchandise, wherein the at least one second object is at least one of a person, a merchandise and a part of a building.

4. The computer implemented method of claim 1, wherein the at least one object source associated with the at least one second object is comprised in the plurality of object sources.

5. The computer implemented method of claim 1, wherein the at least one object source associated with the at least one second object is an image capturing device.

6. The computer implemented method of claim 1, wherein the at least one object source associated with the at least one second object is a storage device.

7. The computer implemented method of claim 1, wherein the virtual combination is based on a spatial relationship between the at least one first object and the at least one second object.

8. The computer implemented method of claim 7, wherein the spatial relationship is determined based on predetermined physical usage of a first object belonging to a category corresponding to the at least one first object in relation to a second object belonging to a category corresponding to the at least one second object.

9. The computer implemented method of claim 7 further comprising presenting a user-interface to enable the user to specify the spatial relationship.

10. The computer implemented method of claim 1, wherein retrieving the at least one first image comprises extracting the at least one first image from an image of the at least one first object.

11. The computer implemented method of claim 10 further comprising presenting a user-interface to enable the user to provide an extraction guidance, wherein the extracting of the at least one first image is based on the extraction guidance.

12. The computer implemented method of claim 1 further comprising transforming at least one of the at least one first image and the at least one second image.

13. The computer implemented method of claim 1 further comprising:
a. determining at least one first spatial dimension of the at least one first object;
b. determining at least one second spatial dimension of the at least one second object; and
c. transforming at least one of the at least one first image and the at least one second image wherein the transforming is based on each of the at least one first spatial dimension and the at least one second spatial dimension.

14. The computer implemented method of claim 13, wherein determining the at least one first spatial dimension comprises analysing the at least one first image, wherein determining the at least one second spatial dimension comprises analysing the at least one second image.

15. The computer implemented method of claim 13, wherein determining the at least one first spatial dimension is based on metadata associated with the at least one first image, wherein determining the at least one second spatial dimension is based on metadata associated with the at least one second image.

16. The computer implemented method of claim 1 further comprising:
a. determining a first point of view corresponding to the at least one first image, wherein the first point of view comprises spatial coordinates of a hypothetical image capturing device relative to spatial coordinates of the at least one first object, wherein the hypothetical image capturing device would capture the at least one first image of the at least one first object;
b. determining a second point of view corresponding to the at least one second image, wherein the second point of view comprises spatial coordinates of a hypothetical image capturing device relative to spatial coordinates of the at least one second object, wherein the hypothetical image capturing device would capture the at least one second image of the at least one second object; and
c. transforming at least one of the at least one first image and the at least one second image, wherein the transforming is based on each of the first point of view and the second point of view.

17. The computer implemented method of claim 19, wherein determining the first point of view comprises analysing the at least one first image, wherein determining the second point of view comprises analysing the at least one second image.

18. The computer implemented method of claim 19 further comprising providing a user-interface to enable the user to provide transformation guidance, wherein transforming at least one of the at least one first image and the at least one second image is based on the transformation guidance.

19. The computer implemented method of claim 1, wherein creating the combination image comprises overlaying the at least one first image onto the at least one second image.

20. The computer implemented method of claim 1 further comprising:
a. presenting a user-interface to enable the user to provide a style; and
b. modifying the at least one second image based on the style, wherein the at least one second object is a person.
